(19) United States
(12) Patent Application Publication
(10) Pub. No.: US 2012/0213499 A1
(43) Pub. Date: Aug. 23, 2012

(54) HEATER BLOCK FOR A RAPID THERMAL PROCESSING APPARATUS IN WHICH A COOLING WATER FLOW IS DIVIDED INTO AN UPPER LAYER AND A LOWER LAYER

(75) Inventors: Jang Woo Shim, Hwaseong-si (KR); Sung Chul Kim, Hwaseong-si (KR); Dong Hyun Kim, Osan-si (KR); Hyo Young Jeon, Cheonan-si (KR)

(73) Assignee: AP SYSTEMS INC, Hwaseong-si (KR)

(21) Appl. No.: 13/391,431

(22) PCT Filed: Aug. 4, 2010
(86) PCT No.: PCT/KR10/05120

§ 371 Date: May 4, 2012

(30) Foreign Application Priority Data
Aug. 21, 2009 (KR) 10-2009-0077708

(51) Int. Cl. F27D 11/12; F28D 15/00

(52) U.S. Cl. 392/411; 165/104.28

(57) ABSTRACT

The present invention relates to a heater block for a rapid thermal processing apparatus, wherein a plurality of lamp pockets (21) for accommodating heating lamps are arranged, and cooling water inlet ports (111a, 111b) and cooling water outlet ports (112a, 112b) are arranged such that the lamp pockets (21) are cooled by the flow of the cooling water fed via the cooling water inlet ports (111a, 111b) and discharged via the cooling water outlet ports (112a, 112b). In detail, the cooling water inlet ports (111a, 111b) and the cooling water outlet ports (112a, 112b) are separately arranged into an upper layer and a lower layer, such that the flow of the cooling water fed via the cooling water inlet ports (111a, 111b) and discharged via the cooling water outlet ports (112a, 112b) is divided into an upper layer and a lower layer. Preferably, cooling water dispersion means (140) are installed at entries of the cooling water inlet ports (111a, 111b) so as to disperse the cooling water in a lateral direction. According to the present invention, the cooling water flows separately in the upper layer and the lower layer to improve cooling efficiency, and particularly, lower portions of the lamp pockets, in which heat discharged by the heating lamps is concentrated, can be maximally cooled. In addition, the cooling water dispersion means prevents the formation of a dead zone, thereby uniformly cooling the entirety of the heater block.

### TECHNICAL FIELD

The present invention relates to a heater block for a rapid thermal processing apparatus, and more particularly, to a heater block for a rapid thermal processing apparatus, which is configured to allow cooling water to flow through upper and lower layers, thereby improving cooling efficiency.

### BACKGROUND ART

In a rapid thermal processing apparatus, cooling of a heater block is performed by circulating cooling water in the heater block to cool lamp pockets for accommodating heating lamps therein. In this case, the flow rate of the cooling water flowing into the heater block through a cooling water inlet port is lowered inside the heater block, thereby causing deterioration in cooling efficiency.

FIG. 1 is a conceptual diagram illustrating a reduction in flow rate of cooling water inside a heater block. Referring to FIG. 1, since flux can be represented by Flux Q=velocity (V)×area (A), the following equations may be obtained assuming that an inflow amount of cooling water is the same as an outflow amount of the cooling water.

Qᵢₙ=Q_{Heater Block}=Qₒᵤₜ (1)

VᵢₙAᵢₙ=V_{HB}A_{HB}=VₒᵤₜAₒᵤₜ (2)

In Equation 2, it can be understood that since Aᵢₙ is the same as Aₒᵤₜ and A_{HB} is greater than Aᵢₙ (or Aₒᵤₜ), Vᵢₙ is the same as Vₒᵤₜ and V_{HB} is less than Vᵢₙ (or Vₒᵤₜ).

In order to increase cooling efficiency, the heater block is configured to ensure rapid circulation of the cooling water therein. Thus, when the circulation of the cooling water is impeded in the heater block as in Equation 2, the cooling efficiency with respect to the heater block is reduced.

Such a conventional heater block has a dead zone to which the cooling water does not sufficiently flow, and FIG. 2 shows the dead zone present in the heater block, in which FIG. 2(a) is a bottom view of the heater block and FIG. 2(b) is a side sectional view of the heater block.

Referring to FIG. 2, in a conventional heater block 10 for a rapid thermal processing apparatus, a cooling water inlet port 11 and a cooling water outlet port 12 are disposed to face each other, so that cooling water flowing into the heater block 10 through the cooling water inlet port 11 is discharged from the heater block 10 through the cooling water outlet port 12 via a plurality of lamp pockets 21 which accommodate heating lamps 20. Here, since a bottleneck 40 is formed near the cooling water inlet port 11, a dead zone 30 is present at both sides near the cooling water inlet port 11 and creates a vortex of the cooling water.

When smooth cooling water flow is obstructed by the vortex in the dead zone 30, the cooling water remains inside the heater block for a long period of time, causing inefficient cooling in the dead zone 30. As a result, halogen lamps 20 in the dead zone 30 often burst or become black due to thermal stress.

### DISCLOSURE

### Technical Problem

Therefore, the present invention is directed to providing a heater block for a rapid thermal processing apparatus, which prevents the creation of a dead zone near a cooling water inlet port and ensures that lower portions of lamp pockets, at which heat discharged from heating lamps is concentrated, are sufficiently cooled, thereby preventing the occurrence of a vortex near the cooling water inlet port, reduction of the lifespan of the heating lamps, and carburization of the heater block.

### Technical Solution

In accordance with one aspect of the present invention, a heater block for a rapid thermal processing apparatus includes a plurality of lamp pockets for accommodating heating lamps, cooling water inlet ports through which cooling water flows into the heater block, and cooling water outlet ports through which the cooling water is discharged from the heater block after cooling the lamp pockets, wherein the cooling water inlet ports are divided into upper and lower inlet ports and the cooling water outlet ports are divided into upper and lower outlet ports such that the flow of the cooling water fed via the cooling water inlet ports and discharged via the cooling water outlet ports is divided into upper and lower flow layers in the heater block.

The heater block may further include a separator plate dividing an interior of the heater block into the upper and lower flow layers such that the flow of the cooling water fed via the cooling water inlet ports and discharged via the cooling water outlet ports is divided into upper and lower flow layers in the heater block.

Each of the cooling water inlet ports may be provided with a cooling water dispersion unit to disperse the cooling water in a lateral direction.

### Advantageous Effects

According to exemplary embodiments of the invention, the heater block for a rapid thermal processing apparatus is configured to allow cooling water to flow through upper and lower flow layers in the heater block, thereby improving cooling efficiency and, in particular, maximizing cooling efficiency with respect to lower portions of lamp pockets, at which heat discharged from heating lamps is concentrated. In addition, the heater block is provided with a cooling water dispersion unit which prevents formation of a dead zone in the heater block, thereby allowing uniform cooling of the heater block.

### DESCRIPTION OF DRAWINGS

FIG. 1 is a conceptual view illustrating reduction in flow rate of cooling water inside a heater block;

FIG. 2 shows a conventional heater block for a rapid thermal processing apparatus, where FIG. 2(a) is a bottom view of the heater block and FIG. 2(b) is a side sectional view of the heater block;

FIGS. 3 and 4 are conceptual views illustrating cooling efficiency with respect to a heater block in which a cooling water flow is not divided into upper and lower flow layers and a heater block in which a cooling water flow is divided into the upper and lower flow layers; and

FIG. 5 shows a heater block for a rapid thermal processing apparatus in accordance with one exemplary embodiment of the present invention, where FIG. 5(a) is a bottom view of the heater block and FIG. 5(b) is a side sectional view of the heater block.

### BEST MODE

Exemplary embodiments of the present invention will now be described in detail with reference to the accompanying drawings. The following embodiments are given by way of illustration only and various modifications will be apparent to a person having ordinary knowledge in the art without departing from the scope of the invention. Therefore, it should be understood that the following embodiments are not to be in any way construed as limiting the scope of the invention.

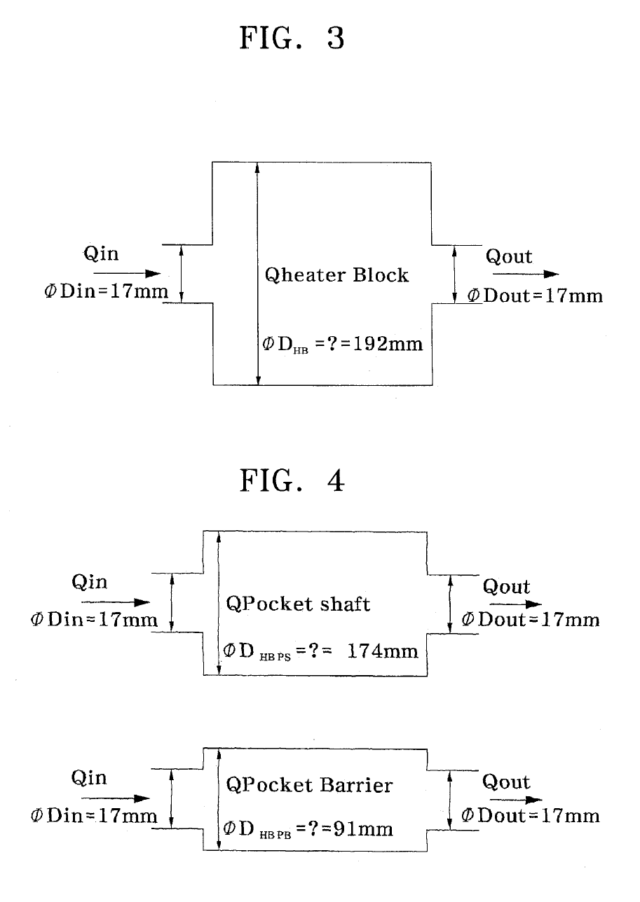

FIGS. 3 and 4 are conceptual views illustrating cooling efficiency with respect to a heater block in which a cooling water flow is not divided into upper and lower flow layers and a heater block in which a cooling water flow is divided into upper and lower flow layers. FIG. 3 shows cooling efficiency with respect to the heater block in which the cooling water flow is not divided into the upper and lower flow layers, and FIG. 4 shows cooling efficiency with respect to the heater block in which the cooling water flow is divided into the upper and lower flow layers.

Referring to FIG. 3, the heater block has an actual volume “a” defined as

$$a = \frac{π {D}_{HB}^{2}}{4} \cdot Height .$$

Herein, the actual volume of the heater block “a” refers to a value obtained by subtracting a volume occupied by lamp pockets from the total volume of the heater block. Assuming D_{BH}=Height,

$${D}_{HB} = \sqrt[3]{\frac{a \times 4}{π}} = 192 mm .$$

Further, since

$${V}_{HB} = \frac{{A}_{IN}}{{A}_{HB}} \cdot {V}_{IN}$$

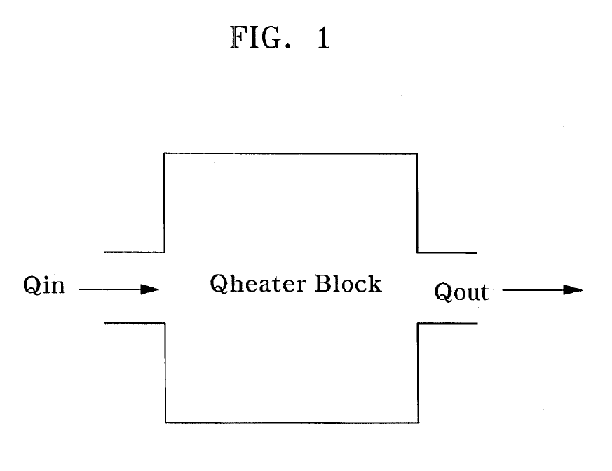

### in Equation 2 of FIG. 1,

$${V}_{HB} = \frac{{D}_{IN}^{2}}{{D}_{IN}^{2}} \times 1 = \frac{{17}^{2}}{{192}^{2}} = 0.0078$$

assuming that Vᵢₙ=Vₒᵤₜ=1. Accordingly, it can be seen that the flow rate in the heater block is 0.0078 times slower than that at inlet ports of the heater block.

Referring to FIG. 4, for a heater block, the interior of which is divided into a pocket shaft and a pocket barrier, that is, an upper flow layer and a lower flow layer, the pocket shaft has a flow rate of

$${V}_{HBPS} = \frac{{D}_{IN}^{2}}{{D}_{HBPS}^{2}} \times 1 = \frac{{17}^{2}}{{174}^{2}} = 0.0095 ,$$

and it can be seen that the flow rate of the pocket shaft is 1.2 times that of the heater block (0.0078) of FIG. 3.

Further, as the pocket barrier has a flow rate of

$${V}_{HBPB} = \frac{{D}_{IN}^{2}}{{D}_{HBPB}^{2}} \times 1 = \frac{{17}^{2}}{{91.4}^{2}} = 0.035 ,$$

it can be seen that the flow rate of the pocket barrier is 4.49 times that of the heater block (0.0078) of FIG. 3. This means that heat transfer capability of the cooling water is 4.49 times greater. Of course, this amount of increase is an optimum modeling value and an actual amount of increase will slightly decrease due to resistance in a flow path in actual application.

As such, when the interior of the heater block is divided into the upper and lower flow layers to allow cooling water to flow through the upper and lower flow layers, the cooling water will have increased heat transfer efficiency.

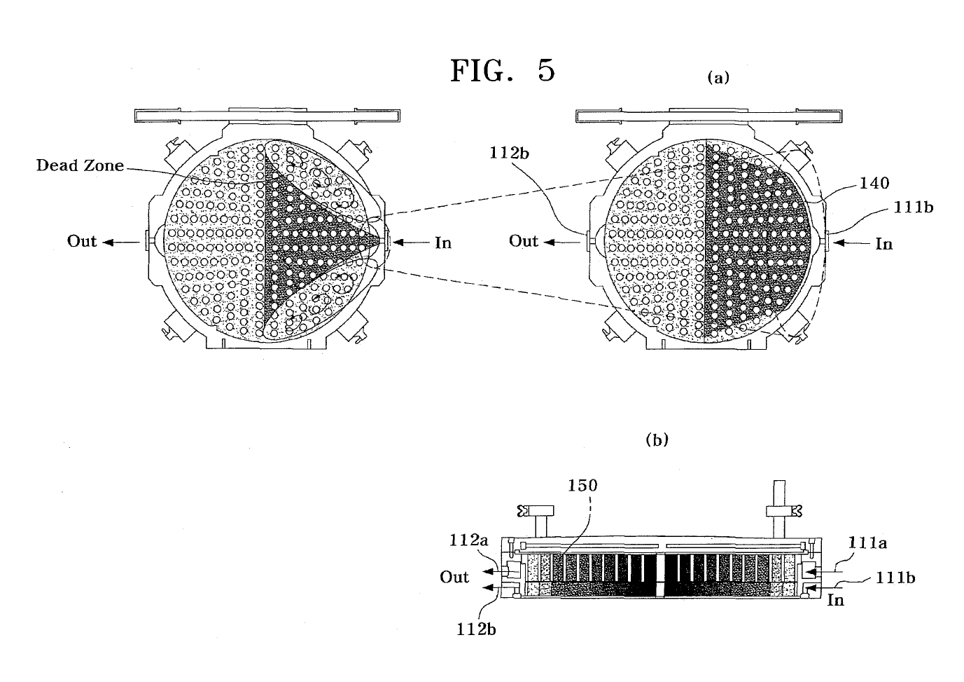

FIG. 5 shows a heater block for a rapid thermal processing apparatus in accordance with one embodiment of the invention, where FIG. 5(a) is a bottom view of the heater block and FIG. 5(b) is a side sectional view of the heater block.

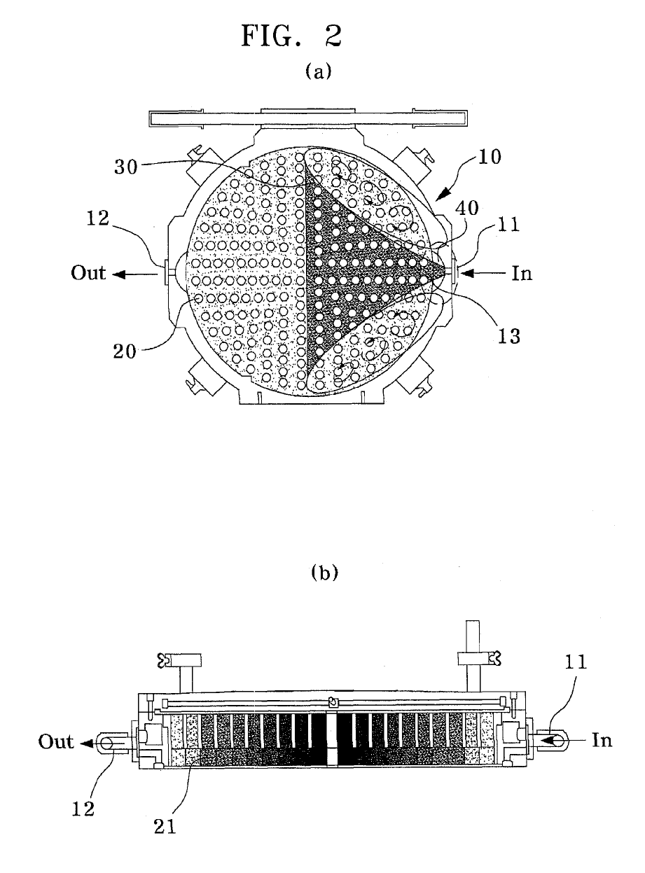

Unlike the configuration shown in FIG. 2, in this embodiment, the heater block include cooling water inlet ports 111a, 111b which are divided into upper and lower inlet ports, and cooling water outlet ports 112a, 112b which are also divided into upper and lower outlet ports, according to the concept illustrated in FIG. 4. In addition, the heater block 10 is provided with a separator plate 150 which divides the interior of the heater block into upper and lower flow layers to allow the cooling water to flow through the upper and lower flow layers in the heater block.

Further, each of the cooling water inlet ports 111a, 111b of the heater block 10 is provided with a cooling water dispersion unit 140 which prevents a bottleneck from being formed near the cooling water inlet ports 111a, 111b. The cooling water dispersion unit 140 may be provided to the heater block in various manners. For example, an elongated buffering space may be defined at either side of the cooling water inlet port to allow the space at either side of the cooling water inlet ports 111a, 111b to be filled with the cooling water. The installation of the cooling water dispersion unit 140 may prevent the formation of the dead zone which creates a vortex of the cooling water in the heater block.

As such, according to the embodiments, the heater block allows cooling water to flow through the upper and lower flow layers, thereby improving cooling efficiency and, in particular, maximizing cooling efficiency with respect to lower portions of lamp pockets, at which heat discharged from heating lamps is concentrated. Further, the heater block is provided with the cooling water dispersion units 140 which prevent formation of a dead zone 30 in the heater block, thereby enabling uniform cooling of the heater block 10.

1. A heater block for a rapid thermal processing apparatus including a plurality of lamp pockets for accommodating heating lamps, cooling water inlet ports through which cooling water flows into the heater block, and cooling water outlet ports through which the cooling water is discharged from the heater block after cooling the lamp pockets, wherein the cooling water inlet ports are divided into upper and lower inlet ports and the cooling water outlet ports are divided into upper and lower outlet ports such that the flow of the cooling water fed via the cooling water inlet ports and discharged via the cooling water outlet ports is divided into upper and lower flow layers in the heater block.

2. The heater block of claim 1, further comprising: a separator plate dividing an interior of the heater block into the upper and lower flow layers such that the flow of the cooling water fed via the cooling water inlet ports and discharged via the cooling water outlet ports is divided into upper and lower flow layers in the heater block.

3. The heater block of claim 1, wherein each of the cooling water inlet ports is provided with a cooling water dispersion unit to disperse the cooling water in a lateral direction.
